(19) United States
(12) Patent Application Publication
(10) Pub. No.: US 2024/0331347 A1
(43) Pub. Date: Oct. 3, 2024

(54) IMAGE PROCESSING DEVICE

(71) Applicant: AISIN CORPORATION, Kariya (JP)

(72) Inventor: Kazuya WATANABE, Kariya-shi (JP)

(73) Assignee: AISIN CORPORATION, Kariya (JP)

(21) Appl. No.: 18/599,564

(22) Filed: Mar. 8, 2024

(30) Foreign Application Priority Data
Mar. 31, 2023 (JP) 2023-059416

(51) Int. Cl. G06V 10/60; G06T 3/4007; G06V 10/25; G06V 20/56

(52) U.S. Cl. CPC G06V 10/60; G06T 3/4007; G06V 10/25; G06V 20/56

(57) ABSTRACT

An image processing device includes: an acquisition unit that acquires a plurality of images of which imaging target regions partially overlap with each other, the plurality of images being captured by a plurality of imaging units provided in a vehicle as a surrounding situation of the vehicle; a region-of-interest setting unit that sets a plurality of regions of interest included in a plurality of overlapping regions in which two adjacent imaging target regions overlap with each other; and a first setting unit that sets a correction value for correcting brightness of the plurality of images based on first target brightness. The first target brightness is a value obtained by adding a first positive value to an average value of brightness of all the regions of interest, and is a value equal to or lower than a first threshold value higher than the first positive value.

### CROSS REFERENCE TO RELATED APPLICATIONS

This application is based on and claims priority under 35 U.S.C. § 119 to Japanese Patent Application 2023-059416, filed on Mar. 31, 2023, the entire content of which is incorporated herein by reference.

### TECHNICAL FIELD

This disclosure relates to an image processing device.

### BACKGROUND DISCUSSION

In the related art, an image processing device is known that images a situation in surroundings of a vehicle by a plurality of imaging units (cameras) provided in the vehicle in different directions, executes image processing on a plurality of images obtained by the imaging (for example, viewpoint conversion), and joins the images to generate a surrounding image (for example, a bird's-eye view image). In such an image processing device, there is a case where lightness (brightness) shift occurs in the image captured by each imaging unit due to an attachment position of the imaging unit, an imaging (image capturing) direction, an imaging time zone, whether headlights are turned on, a degree of difference in stop adjustment for each imaging unit, and the like. As a result, the surrounding image generated by joining the images may have different lightness depending on the direction, a brightness difference may be conspicuous at the joined position, and the image may evoke a sense of discomfort.

Therefore, a technique of correcting the brightness to reduce the sense of discomfort and the like is proposed. For example, a technique of correcting the brightness by using, as a target value, the brightness closest to an average value of the brightness of all images among the averages of the brightness of a plurality of images captured by a plurality of imaging units in a case where the images captured by the plurality of imaging units are combined is proposed (for example, see Japanese Patent No. 3297040 (Reference 1)). In addition, a technique of correcting the brightness to match a fixed target value in a case where images of a plurality of imaging units are combined is proposed (for example, see JP 2019-186620A (Reference 2)).

However, in a case where the brightness is corrected by using, as the target value, the brightness closest to the average value of the brightness of all the images among the averages of the brightness of the plurality of images captured by the imaging units, for example, in a dark environment such as at night, the brightness as the target value is low, and thus the image after the correction is dark as a whole. Therefore, the image after the correction is difficult to see. In addition, in a case where the brightness is corrected to match the fixed target value, the target value in the dark environment such as night is the same as the target value in a bright environment such as daytime, and thus a noise component generated by the imaging in the dark environment such as night is also corrected to be bright. Therefore, the noise component is emphasized, and the image after the correction is difficult to see.

A need thus exists for an image processing device which is not susceptible to the drawback mentioned above.

### SUMMARY

According to an aspect of this disclosure, an image processing device includes an acquisition unit that acquires a plurality of images of which imaging target regions partially overlap with each other, the plurality of images being captured by a plurality of imaging units provided in a vehicle as a surrounding situation of the vehicle, a region-of-interest setting unit that sets a plurality of regions of interest included in a plurality of overlapping regions in which two adjacent imaging target regions overlap with each other, and a first setting unit that sets a correction value for correcting brightness of the plurality of images based on first target brightness, in which the first target brightness is a value obtained by adding a first positive value to an average value of brightness of all the regions of interest, and is a value equal to or lower than a first threshold value higher than the first positive value.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic plan view showing an example of a vehicle in which an image processing device according to an embodiment can be mounted;

FIG. 2 is an exemplary block diagram of a configuration of an image processing system including the image processing device according to the embodiment;

FIG. 3 is an exemplary block diagram of a configuration of a CPU of the image processing device according to the embodiment;

FIG. 4 is a schematic bird's-eye view showing an imaging target region imaged by each imaging unit according to the embodiment, and an overlapping region of the imaging target regions;

FIG. 5 is a schematic diagram showing an example of a brightness distribution and a setting position of a region of interest (ROI) of an original image that is a processing target in the image processing device according to the embodiment;

FIG. 6 is a diagram showing target brightness for a dark mode according to the embodiment;

FIG. 7 is a flowchart showing an example of processing flow in a case where brightness correction is executed using fixed target brightness in the image processing device according to the embodiment;

FIG. 8 is a diagram exemplary showing a part of the processing of the image processing device according to the embodiment, and is a schematic diagram showing that the brightness of the region of interest in the imaging target region in front of a vehicle is corrected to the fixed target brightness and a straight line interpolation expression corresponding to the correction is shown;

FIG. 9 is a diagram showing a case where correction based on the brightness set by the straight line interpolation expression of FIG. 8 is executed, and is a schematic diagram showing an example of a change in a brightness state before and after the correction of the imaging target region in front of the vehicle;

FIG. 10 is a diagram exemplary showing a part of the processing of the image processing device according to the embodiment, and is a schematic diagram showing that the brightness of the region of interest in the imaging target region on a side of the vehicle is corrected to the fixed target brightness and a straight line interpolation expression corresponding to the correction is shown;

FIG. 11 is a schematic diagram showing an example of a brightness state of a surrounding image generated in a case in which the brightness correction is executed on the imaging target region in surroundings of the vehicle; and

FIG. 12 is a schematic diagram showing an example in which a correction amount is limited based on a correction upper limit value and a correction lower limit value according to the embodiment.

### DETAILED DESCRIPTION

Hereinafter, an exemplary embodiment disclosed here will be described. The configurations of the following embodiment, and the actions, results, and effects brought about by the configurations are examples. The present disclosure can also be realized by configurations other than configurations disclosed in the following embodiment, and can achieve at least one of various effects based on the fundamental configurations and derivative effects.

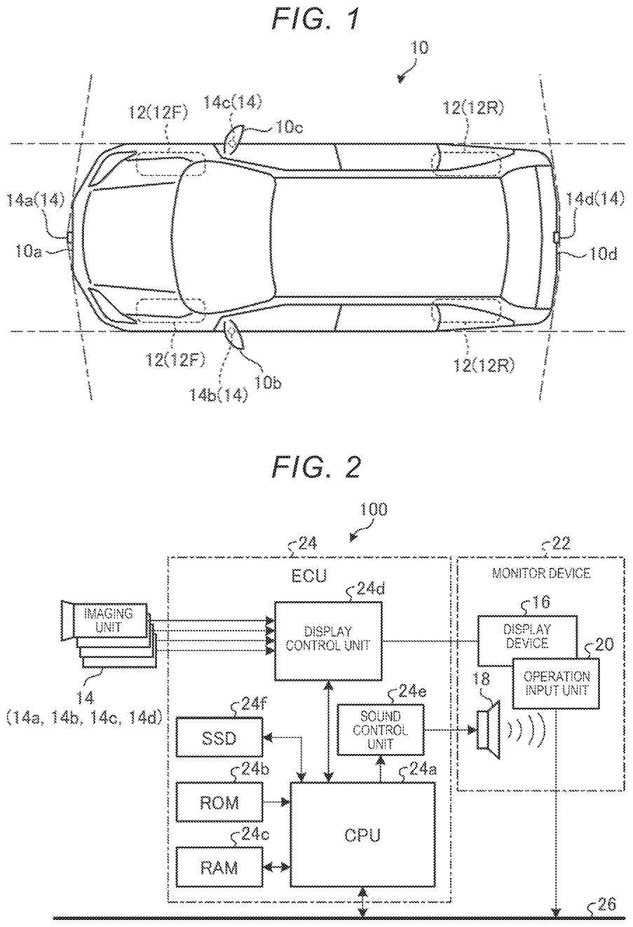

FIG. 1 is a schematic plan view of a vehicle 10 on which an image processing device according to the present embodiment is mounted. The vehicle 10 may be, for example, an automobile (internal combustion engine automobile) having an internal combustion engine (engine, not shown) as a driving source, an automobile (electric automobile, fuel battery automobile, or the like) having an electric motor (motor, not shown) as a driving source, or an automobile (hybrid automobile) having both the internal combustion engine and the electric motor as a driving source. In the vehicle 10, various transmission devices can be mounted, and various devices (system, component, and the like) necessary for driving the internal combustion engine or the electric motor can be mounted. The method, the number, the layout, and the like of the devices related to the driving of vehicle wheels 12 (front vehicle wheels 12F and rear vehicle wheels 12R) in the vehicle 10 can be set in various ways.

As shown in FIG. 1, the vehicle 10 is provided with, for example, four imaging units 14a to 14d as a plurality of imaging units 14. The imaging unit 14 is, for example, a digital camera including an imaging element such as a charge coupled device (CCD) or a CMOS image sensor (CIS). The imaging unit 14 can output moving image data (captured image data, image information) at a predetermined frame rate. Each of the imaging units 14 has a wide-angle lens or a fisheye lens, and can image a range (imaging target region) of, for example, 140° to 220° in a horizontal direction. An optical axis of the imaging unit 14 may be set to be obliquely downward. Therefore, the imaging unit 14 sequentially captures a surrounding situation of the outside of the vehicle 10 including a road surface on which the vehicle 10 is movable, a mark (including an arrow, a partition line, a line indicating a parking space, a lane separation line, and the like) attached to the road surface, or an object (for example, a pedestrian, a vehicle, and the like), and outputs the imaged surrounding situation as captured image data.

The imaging unit 14 is provided in an outer peripheral portion of the vehicle 10. The imaging unit 14a is provided, for example, at an end portion substantially at the center in a vehicle width direction on a front side of the vehicle 10, that is, on a front side in a vehicle front-rear direction, for example, at a front bumper 10a or a front grill, and can capture a front image (front imaging target region) including a front end portion (for example, the front bumper 10a) of the vehicle 10. In addition, the imaging unit 14b is provided at, for example, a left end portion of the vehicle 10, for example, a left side-view mirror 10b, and can image a left-side image (left imaging target region) including a region (for example, a region from a left front side to a left rear side) around a left side of the vehicle 10. In addition, the imaging unit 14c is provided at, for example, a right end portion of the vehicle 10, for example, a right side-view mirror 10c, and can image a right-side image (right imaging target region) including a region (for example, a region from a right front side to a right rear side) around a right side of the vehicle 10. The imaging unit 14d is provided at an end portion substantially at the center in the vehicle width direction on a rear side of the vehicle 10, that is, on a rear side in the vehicle front-rear direction, for example, at an upper position of a rear bumper 10d, and can image a rear image (rear imaging target region) including a rear end portion (for example, the rear bumper 10d) of the vehicle 10.

The image processing device according to the present embodiment can generate an image having a wider viewing angle or generate a virtual image (bird's-eye view image (planar image), a lateral view image, a front view image, or the like) of the vehicle 10 viewed from above, front, side, or the like, by executing calculation processing or image processing based on the captured image data obtained by the plurality of imaging units 14. In the captured image data (image) to be imaged by each imaging unit 14, there are overlapping regions that overlap with each other, and thus an omission region is not generated in a case where the images are joined to each other. For example, an end portion region on the left side in the vehicle width direction of the captured image data captured by the imaging unit 14a and an end portion region on the front side in the vehicle front-rear direction of the captured image data captured by the imaging unit 14b overlap with each other. Then, processing of joining (combining) the two images is executed. Similarly, the overlapping regions are provided for the front image and the right-side image, the left-side image and the rear image, and the rear image and the right-side image, and the processing of joining (combining) the two images is executed.

FIG. 2 is an exemplary block diagram of a configuration of an image processing system 100 including the image processing device mounted on the vehicle 10. A display device 16 and a sound output device 18 are provided in a vehicle cabin of the vehicle 10. The display device 16 is, for example, a liquid crystal display (LCD) or an organic electroluminescent display (OELD). The sound output device 18 is, for example, a speaker. The display device 16 is covered with, for example, a transparent operation input unit 20 such as a touch panel. An occupant (for example, a driver) can visually recognize the image displayed on a display screen of the display device 16 via the operation input unit 20. The occupant can execute the operation input by operating the operation input unit 20 by touching, pressing, or moving the operation input unit 20 with a finger or the like at a position corresponding to the image displayed on the display screen of the display device 16. The display device 16, the sound output device 18, the operation input unit 20, and the like are provided in, for example, a monitor device 22 located at the center of a dashboard of the vehicle 10 in the vehicle width direction, that is, a left-right direction. The monitor device 22 can include an operation input unit (not shown) such as a switch, a dial, a joystick, or a push button. The monitor device 22 can also be used, for example, as a navigation system or an audio system.

In addition, as shown in FIG. 2, the image processing system 100 includes an electronic control unit (ECU) 24 in addition to the imaging units 14 (14a to 14d) or the monitor device 22. In the image processing system 100, the ECU 24 and the monitor device 22 are electrically connected to each other via an in-vehicle network 26 as a telecommunication line. The in-vehicle network 26 is configured as, for example, a controller area network (CAN). The ECU 24 can execute control of various systems by transmitting control signals through the in-vehicle network 26. The ECU 24 can receive an operation signal of the operation input unit 20, operation signals of various switches, detection signals of various sensors (not shown), and the like via the in-vehicle network 26. The ECU 24 is an example of an image processing device.

The ECU 24 transmits data related to the surrounding image or the sound generated based on the captured image data acquired from the imaging unit 14 to the monitor device 22. The ECU 24 includes, for example, a central processing unit (CPU) 24a, a read-only memory (ROM) 24b, a random access memory (RAM) 24c, a display control unit 24d, a sound control unit 24e, and a solid state drive (SSD) 24f.

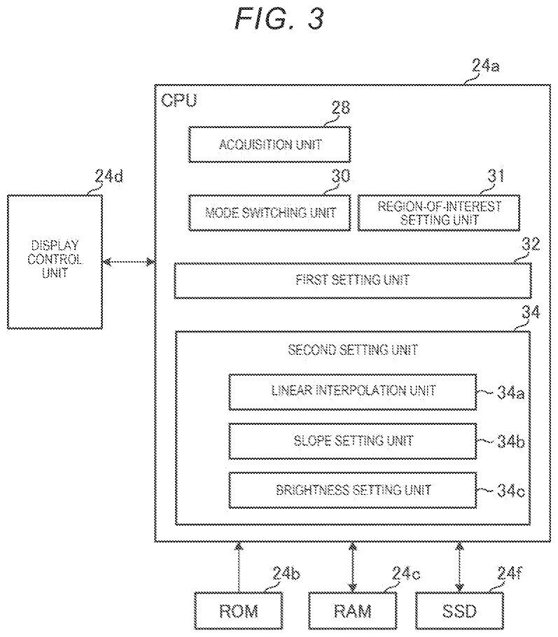

The CPU 24a reads a program stored (installed) in a non-volatile storage device such as the ROM 24b, and executes calculation processing in accordance with the program. The ROM 24b stores each program, parameters required to execute the program, and the like. The CPU 24a includes various modules as shown in FIG. 3, and executes processing related to the image displayed on the display device 16. For example, as an example of the processing, the CPU 24a executes correction processing, calculation processing, image processing, and the like on the captured image data captured by the imaging unit 14 to generate the surrounding image (for example, the bird's-eye view image) in which a plurality of images are joined. Details of the CPU 24a will be described later.

The RAM 24c temporarily stores various data used in the calculation by the CPU 24a. The display control unit 24d mainly executes data conversion or the like of an image for display to be displayed on the display device 16 in the calculation processing in the ECU 24. The sound control unit 24e mainly executes processing of sound data output by the sound output device 18 in the calculation processing in the ECU 24. The SSD 24f is a rewritable non-volatile storage unit, and can store data even in a case where the power of the ECU 24 is turned off. The CPU 24a, the ROM 24b, the RAM 24c, and the like may be integrated in the same package. The ECU 24 may be configured to use another logical and arithmetic processor such as a digital signal processor (DSP) or a logical circuit instead of the CPU 24a. In addition, a hard disk drive (HDD) may be provided instead of the SSD 24f, and the SSD 24f or the HDD may be provided separately from the ECU 24.

In the present embodiment, the ECU 24 controls image generation processing of the image to be displayed on the display device 16 by the hardware and the software (control program) cooperating with each other. The ECU 24 executes brightness correction of the image in a case where the captured image data (image) captured by the imaging unit 14 is subjected to the image processing, for example, viewpoint conversion processing and displayed on the display device 16. The ECU 24 reduces the inconvenience of the continuity between the images being reduced due to a brightness difference in a case where the front, rear, left, and right images are joined, and an entirety or a part of the image from becoming too bright or too dark, and prevents the visibility of the entire image (surrounding image and bird's-eye view image generated by joining) from being reduced.

FIG. 3 is an exemplary block diagram of a configuration for realizing the image processing according to the present embodiment in the CPU 24a included in the ECU 24. In addition, in the CPU 24a, a configuration other than a configuration for executing the image processing according to the present embodiment is not shown. The CPU 24a includes various modules for executing the image processing including the above-described brightness correction. The various modules are realized by the CPU 24a reading the program installed and stored in the storage device such as the ROM 24b and executing the program. For example, as shown in FIG. 3, the CPU 24a includes an acquisition unit 28, a mode switching unit 30, a region-of-interest setting unit 31, a first setting unit 32 (first setting unit), a second setting unit 34 (second setting unit), and the like. In addition, the second setting unit 34 includes a linear interpolation unit 34a, a slope setting unit 34b, a brightness setting unit 34c, and the like.

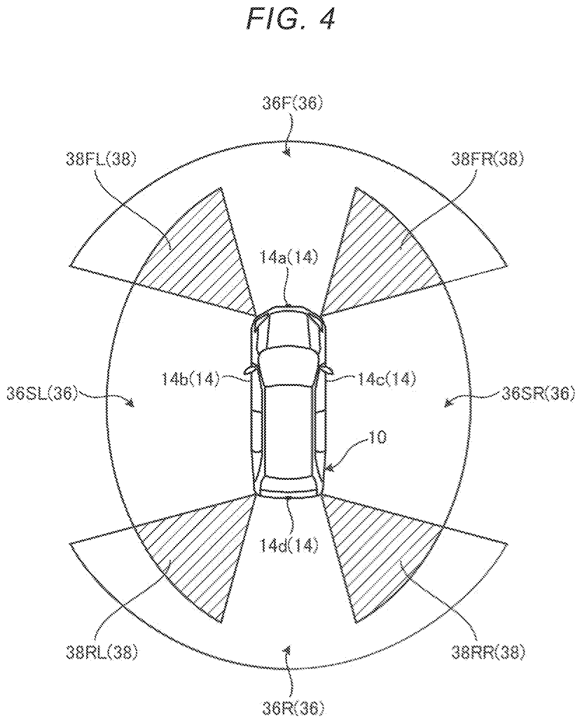

The acquisition unit 28 acquires the image captured by each imaging unit 14 via the display control unit 24d. Each of the imaging units 14 (14a to 14d) can image an imaging target region 36 as shown in FIG. 4. Then, each imaging target region 36 has an overlapping region 38 in which a part thereof overlaps with the adjacent imaging target region 36 as described above. An overlapping region 38FL is formed between the left side in the vehicle width direction of an imaging target region 36F in front of the vehicle 10 and the vehicle front side of an imaging target region 36SL on the left side of the vehicle 10 in the imaging target region 36. An overlapping region 38RL is formed between the vehicle rear side of the imaging target region 36SL and the left side in the vehicle width direction of an imaging target region 36R behind the vehicle 10 in the imaging target region 36. An overlapping region 38RR is formed between the right side in the vehicle width direction of the imaging target region 36R and the vehicle rear side of an imaging target region 36SR on the right side of the vehicle 10 in the imaging target region 36. An overlapping region 38FR is formed between the vehicle front side of the imaging target region 36SR and the right side in the vehicle width direction of the imaging target region 36F in the imaging target region 36. Each imaging unit 14 may attach an identification code of each imaging unit 14 to the obtained captured image data and output the captured image data with the identification code to the acquisition unit 28, or may attach an identification code for identifying an output source for each captured image data acquired on the acquisition unit 28 side.

In the present embodiment, for example, in a case where the processing is executed with a focus on the imaging target region 36F, one (for example, the imaging target region 36F) of a pair of imaging target regions 36 (for example, the imaging target region 36F and the imaging target region 36R) separated from each other with the vehicle 10 interposed therebetween may be referred to as a first imaging target region. In addition, one (for example, the imaging target region 36SL) of a pair of imaging target regions 36 (for example, the imaging target region 36SL and the imaging target region 36SR) adjacent to the first imaging target region may be referred to as a second imaging target region. The overlapping region 38 (overlapping region 38FL) in which the first imaging target region and the second imaging target region overlap with each other may be referred to as a first overlapping region. Similarly, the other (for example, the imaging target region 36SR) of the pair of imaging target regions 36 (for example, the imaging target region 36SL and the imaging target region 36SR) adjacent to the first imaging target region may be referred to as a third imaging target region. The overlapping region 38 (overlapping region 38FR) in which the first imaging target region and the third imaging target region overlap with each other may be referred to as a second overlapping region. The pair of imaging target regions 36 separated from each other with the vehicle 10 interposed therebetween can be, for example, the imaging target region 36SL and the imaging target region 36SR. In this case, the second imaging target region is any one of the imaging target region 36F and the imaging target region 36R, and the third imaging target region is the other.

The mode switching unit 30 switches (sets) a target setting mode based on information (hereinafter, also referred to as lightness information) on the lightness. The target setting mode is, for example, a bright mode and a dark mode. That is, the mode switching unit 30 switches between the bright mode and the dark mode based on the lightness information. The bright mode is an example of a second mode and is also referred to as a daytime mode. The dark mode is an example of a first mode and is also referred to as a night mode.

The lightness information is, for example, brightness of an image captured by the imaging unit 14 and acquired by the acquisition unit 28. The mode switching unit 30 sets the target setting mode to the bright mode, for example, in a case where the ECU 24 is started up. The mode switching unit 30 switches the target setting mode to the dark mode in a case where the target setting mode is set to the bright mode and average brightness of the image captured by any of the imaging units is equal to or lower than a threshold value for dark mode switching. The threshold value for dark mode switching is, for example, 80, but is not limited thereto. The mode switching unit 30 switches the target setting mode to the bright mode in a case where the target setting mode is set to the dark mode and average brightness of the images captured by all the imaging units 14 is equal to or higher than a threshold value for bright mode switching. The threshold value for bright mode switching is, for example, 120, but is not limited thereto.

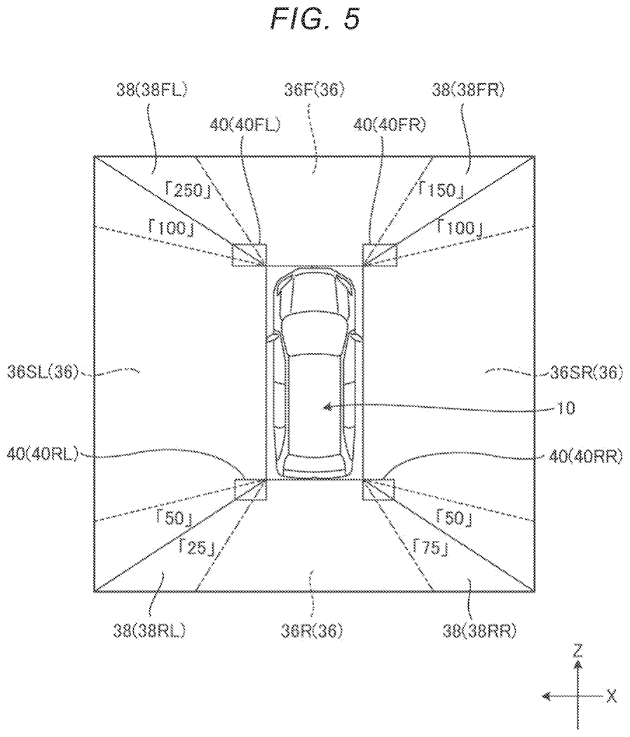

As shown in FIG. 5, the region-of-interest setting unit 31 sets a plurality of regions of interest 40 (40FL, 40RL, 40RR, 40FR) to be referred to in a case where the brightness adjustment is executed, in the plurality of overlapping regions 38 of the imaging target regions 36 acquired by the acquisition unit 28. One region of interest 40 is set for one overlapping region 38. The region of interest 40 is, for example, a rectangular region having a predetermined length in the vehicle width direction and the front-rear direction of the vehicle 10, and the brightness of the region of interest 40 is, for example, an average value of the brightness of each pixel included in the region of interest 40. In addition, in a case where a position of the region of interest 40 is specified in the present embodiment, the position is, for example, a center position of the region of interest 40 (midpoint in the vehicle width direction and the front-rear direction).

Each imaging unit 14 is automatically subjected to stop adjustment (gain adjustment) during the imaging, and the lightness adjustment (brightness adjustment) of each imaging target region 36 is executed. As a result, in a case where there are many bright regions in the imaging target regions 36, a stop value is increased, and a dark image in which the lightness is reduced is captured. On the contrary, in a case where there are many dark regions in the imaging target regions 36, the stop value decreases, and a bright image in which the lightness is improved is captured. Therefore, as shown in FIG. 5, for example, in a region of interest 40FL included in the overlapping region 38FL, the lightness (brightness) may be different between a portion corresponding to the region of interest 40FL on the imaging target region 36F side and a portion corresponding to the region of interest 40FL on the imaging target region 36SL side. For example, in FIG. 5, in a case where the brightness is expressed in 256 gradations of 0 to 255 (“0” is dark and “255” is bright), for example, in a case of the region of interest 40FL included in the overlapping region 38FL, the brightness on the side of the imaging target region 36F is “250” and bright, and the brightness on the imaging target region 36SL side is “100” and darker than the imaging target region 36F side. In FIG. 5, a numeral marked as “100” and the like indicate the brightness. In addition, in another diagram, the numeral marked in the region of interest 40 may indicate the brightness. The region-of-interest setting unit 31 may set a setting position of the region of interest 40 to a position determined in advance, or may change the setting position in accordance with the brightness distribution of the imaging target region 36.

The first setting unit 32 sets a correction value for correcting the brightness of the plurality of images based on the first target brightness. Specifically, the first setting unit 32 corrects the brightness of the region of interest 40 using a predetermined value. For example, the first imaging target region (for example, the imaging target region 36F) which is one of the pair of imaging target regions 36 (for example, the imaging target region 36F and the imaging target region 36R) separated from each other with the vehicle 10 interposed therebetween is considered. The first setting unit 32 corrects the brightness of the first region of interest (for example, the region of interest 40FL) included in the first overlapping region (for example, the overlapping region 38FL) in which the first imaging target region (for example, the imaging target region 36F) and the second imaging target region (for example, the imaging target region 36SL) which is one of the pair of imaging target regions 36 adjacent to the first imaging target region overlap with each other. Similarly, the first setting unit 32 corrects the brightness of the second region of interest (for example, a region of interest 40FR) included in the second overlapping region (for example, the overlapping region 38FR) in which the first imaging target region (for example, the imaging target region 36F) and the third imaging target region (for example, the imaging target region 36SR) which is the other of the imaging target regions 36 adjacent to the first imaging target region overlap with each other. Similarly, the first setting unit 32 corrects the brightness of a region of interest 40RL and a region of interest 40RR.

In the present embodiment, in a case where the brightness of the region of interest 40 is corrected using the predetermined value, the first setting unit 32 can execute the correction using, for example, the target brightness depending on the bright mode and the dark mode.

For example, in the bright mode, the first setting unit 32 determines a correction value to be a target brightness value for a bright mode, which is the target brightness for a bright mode determined as the predetermined value, and corrects the brightness. For example, in the bright mode, the first setting unit 32 executes the correction using the correction value such that the brightness of the region of interest 40 is set to the target brightness for a bright mode (for example, “200” of 256 gradations) which is relatively easy to see and is derived in advance by an experiment or the like. The target brightness for a bright mode is not limited to “200” of 256 gradations, and may be, for example, “130” or the like.

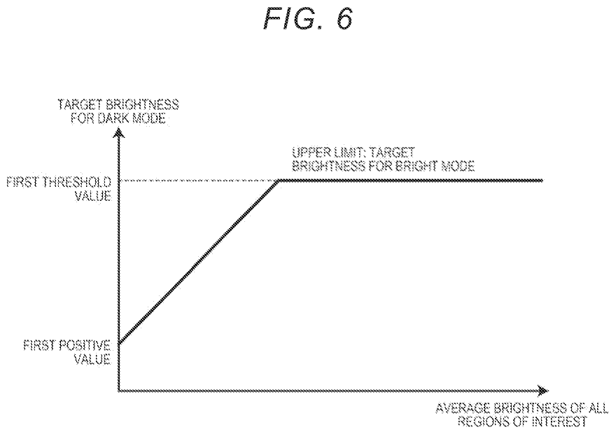

In addition, in the dark mode, the first setting unit 32 executes the correction using the correction value such that the brightness of the region of interest 40 is set to the target brightness for a dark mode which is the target brightness for a dark mode. As shown in FIG. 6, the target brightness for a dark mode is a value obtained by adding a first positive value to the average value (average brightness of all the regions of interest) of the brightness of all the regions of interest 40 (40FL, 40RL, 40RR, 40FR), and is a value equal to or lower than a first threshold value higher than the first positive value. The target brightness for a dark mode is equal to or lower than the target brightness for a bright mode. In other words, the target brightness for a bright mode is equal to or higher than the target brightness for a dark mode. The first positive value is, for example, “20”, but is not limited thereto. A specific example of the correction by the first setting unit 32 will be described later.

That is, the first setting unit 32 sets a first correction value and a second correction value using the target brightness for a dark mode (first target brightness) in the dark mode (first mode), and sets the first correction value and the second correction value using the target brightness for a bright mode, which is equal to or higher than the target brightness for a dark mode (second target brightness), in the bright mode (second mode).

The second setting unit 34 sets the brightness between at least the adjacent regions of interest 40 based on the correction value of each of the adjacent regions of interest 40. For example, in a case where the region of interest 40FL on the left side of the imaging target region 36F in the vehicle width direction is set as the first region of interest, for example, a correction value for the correction to fixed target brightness set by the first setting unit 32 is set as the first correction value. Similarly, in a case where the region of interest 40FR on the right side of the imaging target region 36F in the vehicle width direction is set as the second region of interest, for example, a correction value for the correction to fixed target brightness set by the first setting unit 32 is set as the second correction value. In this case, the linear interpolation unit 34a generates, for example, a straight line interpolation expression (straight line connecting the first correction value and the second correction value) for executing linear interpolation using the first correction value and the second correction value. Then, the brightness of the region between the two regions of interest 40 is corrected based on the generated linear interpolation expression (straight line interpolation expression). That is, the linear interpolation unit 34a generates the straight line interpolation expression by connecting the correction values for two adjacent regions of interest 40 with a straight line, as an example.

The slope setting unit 34b corrects a slope of the straight line interpolation expression in a case where a slope of the linear interpolation expression generated by the linear interpolation unit 34a is equal to or higher than a predetermined limit value. For example, in a case where the brightness of one of the adjacent regions of interest 40 is significantly different from the target brightness set by the first setting unit 32, the slope of the straight line interpolation expression generated by the linear interpolation unit 34a is increased. As a result, for example, in the surroundings of the region of interest 40, a portion darker than the region of interest 40 may also be corrected to be brighter under the influence of the correction of the brightness of the region of interest 40. As a result, the correction is executed such that the brightness is higher than necessary, and so-called “overexposure” may occur. The slope setting unit 34b corrects the slope of the linear interpolation expression generated by the linear interpolation unit 34a by a predetermined magnification. For example, the magnification is set to 1 in a case where the slope of the linear interpolation expression is lower than the limit value, and is set to a value higher than 0 and lower than 1 in order to correct and reduce the slope in a case where the slope is equal to or higher than the predetermined value.

The brightness setting unit 34c sets an individual correction value for correcting the brightness of the region between at least the first region of interest (for example, the region of interest 40FL) and the second region of interest (for example, the region of interest 40FR) based on the linear interpolation expression (for example, the straight line interpolation expression) generated by the linear interpolation unit 34a. In a case where the linear interpolation expression generated by the linear interpolation unit 34a is the linear interpolation expression related to the imaging target region 36F in front of the vehicle 10, the brightness setting unit 34c executes the brightness correction in the same manner on the region in the vehicle front-rear direction in the imaging target region 36F in accordance with the linear interpolation expression. Therefore, in a case of the imaging target region 36F, the correction of the brightness is executed using the same correction value (correction amount) in the region in the vehicle front-rear direction. The brightness setting unit 34c sets a correction upper limit value and a correction lower limit value for the individual correction value.

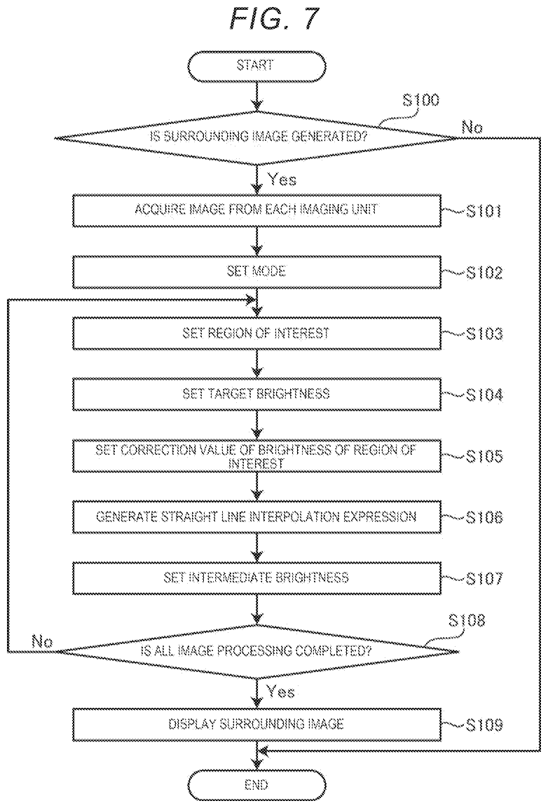

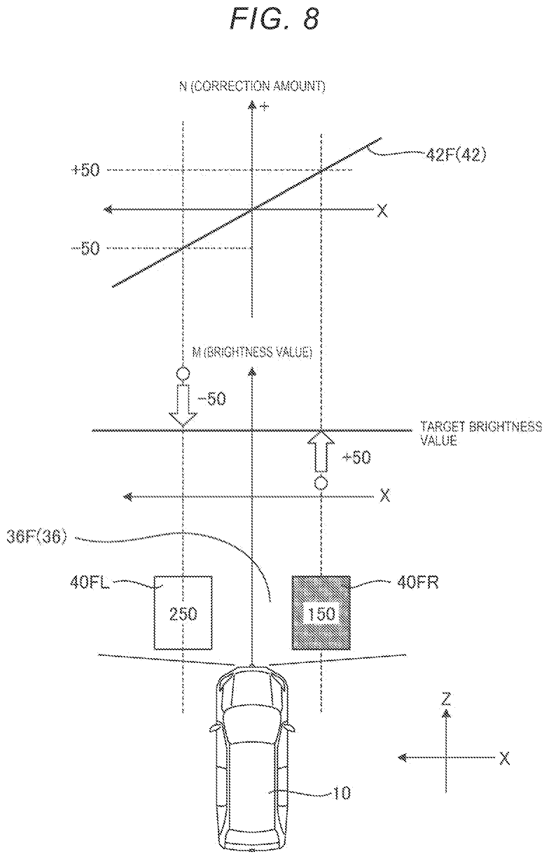

An example of the processing of the image processing system 100 (ECU 24) configured as described above will be described with reference to the flowchart of FIG. 7, and FIGS. 8 to 12 in addition to FIGS. 1 to 5.

The brightness correction executed in a case where the target brightness (target brightness for a bright mode, target brightness for a dark mode) is set as a predetermined value by the first setting unit 32 will be described with reference to the flowchart of FIG. 7.

First, the CPU 24a determines whether a timing to generate the surrounding image in a bird's-eye view around the vehicle 10 has arrived (S100). In this determination, for example, the CPU 24a executes an affirmative determination in a case where the vehicle 10 is in an operation state (for example, in a case where a shift lever is moved to a position of a backward movement) or a display request operation of the driver is executed via the operation input unit 20. In a case where the CPU 24a determines to generate the surrounding image (Yes in S100), the acquisition unit 28 acquires the image (image information) of the imaging target region 36 imaged by each imaging unit 14 (S101). In a case where it is determined that the timing to generate the surrounding image has not arrived (No in S100), the flow of FIG. 7 is temporarily finished.

Subsequently, the mode switching unit 30 sets the mode (target setting mode) (S102). The mode switching unit 30 selectively sets the bright mode and the dark mode by the above-described method.

Subsequently, the region-of-interest setting unit 31 sets the region of interest 40 for the imaging target region 36 of each acquired image (S103).

In addition, the first setting unit 32 sets the target brightness (target brightness for a bright mode, target brightness for a dark mode) depending on the set target setting mode (S104). Hereinafter, first, a case of the bright mode will be described as the processing in and after S104.

In the bright mode, in a case where the brightness in the region of interest 40 of each imaging target region 36 is, for example, as shown in FIG. 5, the first setting unit 32 sets the target brightness for a bright mode determined as the predetermined value (for example, “200” in 256 gradations) for each region of interest 40 (S104), and sets the correction value for correcting the brightness of the region of interest 40 to the target brightness (for example, “200”) (S105). FIG. 8 is an example in which the brightness of the imaging target region 36F in front of the vehicle 10 is corrected, and is an example of the correction in the bright mode. In a case of the imaging target region 36F, the brightness of the region of interest 40FL on the left side in the vehicle width direction (X-axis direction) is “250” in 256 gradations, and the brightness of the region of interest 40FR on the right side in the vehicle width direction is “150” in 256 gradations. On the other hand, in a case where the target brightness set by the first setting unit 32 is “200” in 256 gradations, in the imaging target region 36F, the correction value of “−50” is set as a brightness value M in the region of interest 40FL, and the correction value of “+50” is set in the region of interest 40FR.

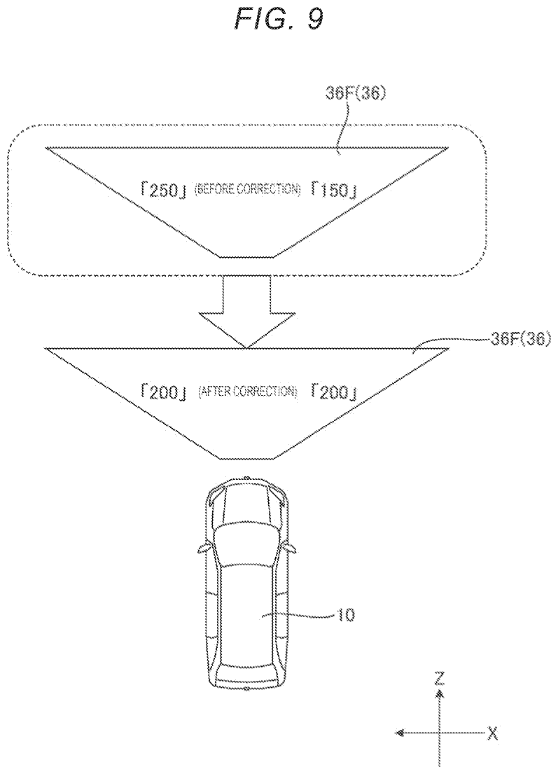

The linear interpolation unit 34a generates a straight line interpolation expression 42 (42F) using the correction value (N=−50) of the region of interest 40FL and the correction value (N=+50) of the region of interest 40FR which are set by the first setting unit 32 (S106). As a result, the correction amount of the brightness in the vehicle width direction (X-axis direction) between the region of interest 40FL and the region of interest 40FR is indicated by the straight line interpolation expression 42F. The brightness setting unit 34c corrects (sets) the brightness of the region between the region of interest 40FL and the region of interest 40FR based on the correction value (individual correction value) calculated by the generated straight line interpolation expression 42F. Similarly, in the imaging target region 36F, the brightness of the region in the vehicle front-rear direction (Z-axis direction) is set (corrected) using the same correction value (S107). As a result, as shown in FIG. 9, the imaging target region 36F before the correction is corrected such that the brightness on the left side in the vehicle width direction (portion of the region of interest 40FL) is reduced from, for example, “250” to “200”, and is corrected such that the brightness on the right side in the vehicle width direction (portion of the region of interest 40FR) is increased from, for example, “150” to “200”.

The CPU 24a monitors whether the correction processing as described above is completed for the entire screen (S108). Then, in a case where the correction processing is not completed (No in S108), the processing returns to S101, and the region-of-interest setting unit 31, the first setting unit 32, and the second setting unit 34 execute the above-described processing on the imaging target region 36R, the imaging target region 36SL, and the imaging target region 36SR.

For example, the region-of-interest setting unit 31, the first setting unit 32, and the second setting unit 34 execute the same processing as described above on the imaging target region 36R behind the vehicle 10. As a result, the imaging target region 36R before the correction is corrected such that the brightness on the left side in the vehicle width direction (portion of the region of interest 40RL) is increased from “50” to “200”, and is corrected such that the brightness on the right side in the vehicle width direction (portion of the region of interest 40RR) is increased from “50” to “200”.

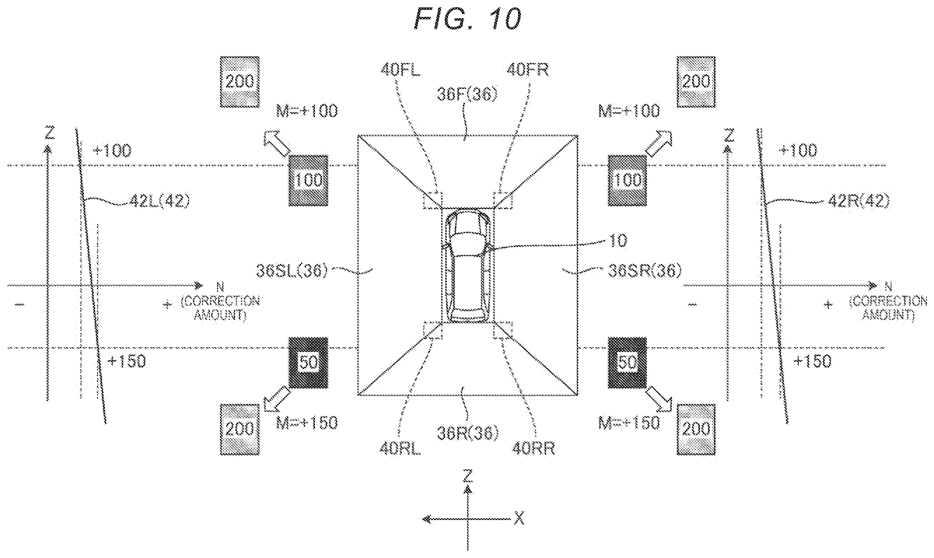

Similarly, as shown in FIG. 10, the region-of-interest setting unit 31, the first setting unit 32, and the second setting unit 34 execute the same correction on the imaging target region 36SL on the left side of the vehicle 10 and the imaging target region 36SR on the right side of the vehicle 10. For example, in a case of the imaging target region 36SL, the brightness of the region of interest 40FL on the front side in the vehicle front-rear direction (Z-axis direction) is “100” in 256 gradations, and the brightness of the region of interest 40RL on the rear side is “50” in 256 gradations. On the other hand, in a case where the target brightness set by the first setting unit 32 is “200” in 256 gradations, the first setting unit 32 sets the correction value of “+100” as the brightness value M in the region of interest 40FL, and sets the correction value of “+150” in the region of interest 40RL on the rear side. The linear interpolation unit 34a generates a straight line interpolation expression 42L using the correction value (N=+100) of the region of interest 40FL and the correction value (N=+150) of the region of interest 40RL which are set by the first setting unit 32. Similarly, in a case of the imaging target region 36SR, the brightness of the region of interest 40FR on the front side in the vehicle front-rear direction (Z-axis direction) is “100” in 256 gradations, and the brightness of the region of interest 40RR on the rear side is “50” in 256 gradations. On the other hand, in a case where the target brightness set by the first setting unit 32 is “200” in 256 gradations, the first setting unit 32 sets the correction value of “+100” as the brightness value M in the region of interest 40FR, and sets the correction value of “+150” in the region of interest 40RR on the rear side. The linear interpolation unit 34a generates a straight line interpolation expression 42R using the correction value (N=+100) of the region of interest 40FR and the correction value (N=+150) of the region of interest 40RR which are set by the first setting unit 32.

As a result, the correction amount of the brightness in the vehicle front-rear direction (Z-axis direction) between the region of interest 40FL and the region of interest 40RL in the imaging target region 36SL is indicated by the straight line interpolation expression 42L, and the individual correction amount of the brightness in the vehicle front-rear direction (Z-axis direction) between the region of interest 40FR and the region of interest 40RR in the imaging target region 36SR is indicated by the straight line interpolation expression 42R. The brightness setting unit 34c corrects the brightness of the region between the region of interest 40FL and the region of interest 40RL and the brightness of the region in the vehicle width direction (X-axis direction) in the imaging target region 36SL by the same individual correction amount based on the straight line interpolation expression 42L. The brightness setting unit 34c corrects the brightness of the region between the region of interest 40FR and the region of interest 40RR and the brightness of the region in the vehicle width direction (X-axis direction) in the imaging target region 36SR by the same individual correction amount based on the straight line interpolation expression 42R.

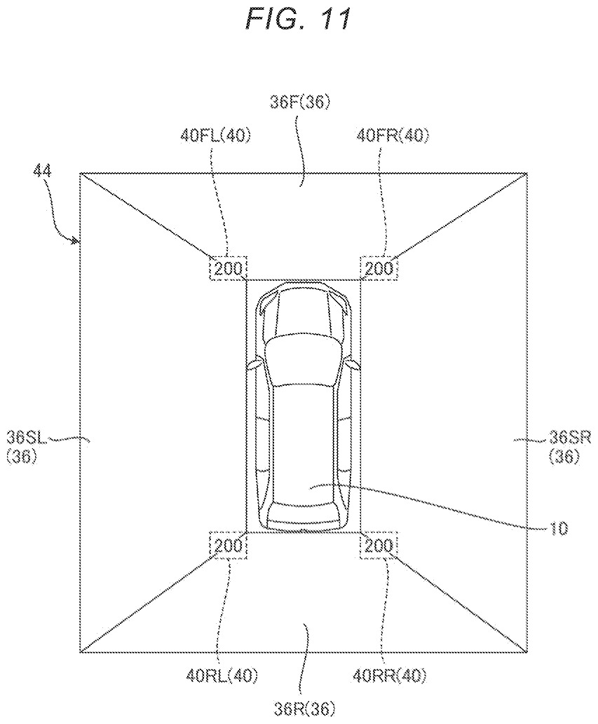

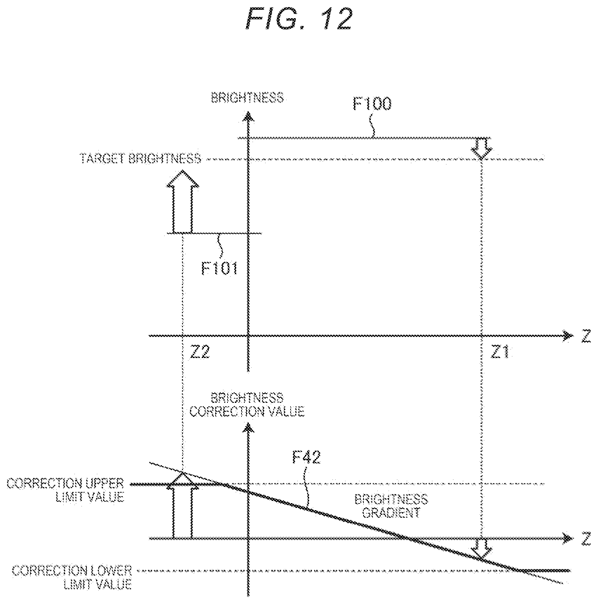

In a case where the correction processing is completed for all the images (images of the imaging target region 36F, the imaging target region 36R, the imaging target region 36SL, and the imaging target region 36SR) (Yes in S108), the CPU 24a uses the display control unit 24d to join the images to generate the surrounding image for the bird's-eye view, displays the surrounding image on the display device 16 (S109), and repeats the processing from S100 in the next processing cycle to update the surrounding image. In this case, as shown in FIG. 11, it is possible to generate a surrounding image 44 in which the brightness of each of the regions of interest 40 (40FL, 40RL, 40RR, 40FR) is “200” in 256 gradations and each of the imaging target regions 36 (36F, 36SL, 36R, 36SR) is smoothly joined. In addition, since the brightness between the regions of interest 40 is also corrected by the straight line interpolation expression 42, a too bright portion and a too dark portion are prevented from being generated, and the image content is easily recognized in any portion of the surrounding image 44.

In the above-described processing, in a case where the dark mode is set in S102, the target brightness for a dark mode is set in S104, and the processing in and after S105 is executed in the same manner as in the bright mode using the target brightness for a dark mode. In this case, as an example, an example of the brightness before the correction is as follows. In the region of interest 40FL, the brightness on the imaging target region 36F side is “50”, and the brightness on the imaging target region 36SL side is “140”. In addition, in the region of interest 40FR, the brightness on the imaging target region 36F side is “45”, and the brightness on the imaging target region 36SR side is “100”. In addition, in the region of interest 40RL, the brightness on the imaging target region 36SL side is “35”, and the brightness on the imaging target region 36R side is “80”. In the region of interest 40RR, the brightness on the imaging target region 36SR side is “70”, and the brightness on the imaging target region 36R side is “30”. The brightness is corrected using the target brightness for a dark mode. The brightness is not limited to the above example.

Incidentally, the brightness difference between the adjacent regions of interest 40 may be originally large. In such a case, as in the above-described case, in a case where the first setting unit 32 sets the target brightness, the straight line interpolation expression 42 having a large slope may be generated. In this case, for example, the pixel may be corrected to be too bright, and so-called “overexposure” may occur. Therefore, the slope setting unit 34b can correct the slope of the straight line interpolation expression 42 generated by the linear interpolation unit 34a by the above-described predetermined magnification.

In addition, in the embodiment, the brightness setting unit 34c may limit the correction value (individual correction value) in a case where the correction value for correcting the brightness is set based on the straight line interpolation expression 42. For example, as shown in FIG. 12, the correction upper limit value and the correction lower limit value are set for the correction value, and in accordance with the straight line interpolation expression 42, the individual correction amount to be set is made to fall between the correction upper limit value and the correction lower limit value as the correction amount of the brightness is increased. Also in this case, the correction amount of the brightness is relaxed, and the “overexposure” can be reduced. In FIG. 12, as an example, Z1 indicates the coordinates of the region of interest 40FL, Z2 indicates the coordinates of the region of interest 40RR, F100 indicates the brightness of the region of interest 40FL before the correction, and F101 indicates the brightness of the region of interest 40RR before the correction. The correction upper limit value and the correction lower limit value may be set as fixed values in advance, or may be set in accordance with the slope of the calculated straight line interpolation expression 42.

As described above, in the present embodiment, the target brightness for a dark mode (first target brightness) is the value obtained by adding the first positive value to the average value of the brightness of all the regions of interest 40, and is the value equal to or lower than the first threshold value higher than the first positive value.

With such a configuration, for example, since the first target brightness is the value obtained by adding the first positive value to the average value of the brightness of all the regions of interest 40, and is the value equal to or lower than the first threshold value higher than the first positive value, it is possible to increase the brightness of the image captured in a relatively dark environment and to prevent the noise component of the image from being emphasized. Therefore, even in a case where a plurality of images captured in the relatively dark environment are joined to display the surrounding image, it is possible to prevent the image from becoming difficult to see.

In addition, in the present embodiment, the mode switching unit 30 switches between the dark mode (first mode) and the bright mode (second mode) based on the information on the lightness. The first setting unit 32 sets the first correction value and the second correction value using the target brightness for a dark mode in the dark mode, and sets the first correction value and the second correction value using the target brightness for a bright mode, which is equal to or higher than the target brightness for a dark mode, in the bright mode.

With such a configuration, the target brightness can be set depending on the dark mode and the bright mode.

The target brightness for a bright mode is a first threshold value.

With such a configuration, since the target brightness for the bright mode is the first threshold value, it is possible to prevent the brightness to be corrected in the dark mode from becoming too high.

The second setting unit 34 sets the correction upper limit value and the correction lower limit value for the individual correction value.

With such a configuration, it is possible to prevent the brightness from being corrected to be extremely high, and to prevent the image from becoming unnaturally too bright or too dark.

The second setting unit 34 calculates the individual correction value based on the interpolation expression for linear interpolation between the first correction value and the second correction value, and the slope of the interpolation expression is adjustable.

With such a configuration, for example, it is possible to prevent the brightness from becoming extremely high and to prevent the image from becoming unnaturally too bright or too dark.

In the present embodiment, the imaging unit 14b is fixed to the left side-view mirror 10b, and the imaging unit 14c is fixed to the right side-view mirror 10c. In this case, by using the image captured in a state where a door of the vehicle 10 is closed, the images captured by the imaging unit 14a and the imaging unit 14d can be accurately joined. Therefore, in a case where the door is open, the display control unit 24d cannot accurately join the images. Therefore, the CPU 24a may generate the surrounding image as a reference without executing the above-described brightness correction processing.

A configuration may be adopted in which a program for the image processing executed by the CPU 24a according to the present embodiment is recorded in a file in an installable format or an executable format in a computer-readable recording medium such as a CD-ROM, a flexible disk (FD), a CD-R, or a digital versatile disk (DVD) and provided.

Further, a configuration may be adopted in which the image processing program is stored in a computer connected to a network such as the Internet and provided by being downloaded via the network. In addition, a configuration may be adopted in which the image processing program executed in the present embodiment is provided or distributed via a network such as the Internet.

In the above-described embodiment, an example is described in which the information (lightness information) on the lightness used to switch between the bright mode and the dark mode is the brightness of the image, but this disclosure is not limited thereto. For example, the information on the lightness may be information (illumination switch signal) indicating a state (on state or off state) of an illumination switch of the vehicle 10 or a detection result (automatic light control sensor signal) of a corner light sensor. For example, in a case where the information on the lightness is the illumination switch, the mode switching unit 30 sets the bright mode in a case where the illumination switch is turned off, and sets the dark mode in a case where the illumination switch is turned on. In addition, in a case where the information on the lightness is information detected by an automatic light control sensor, the mode switching unit 30 sets the bright mode in a case where the lightness in the surroundings of the vehicle 10 detected by the automatic light control sensor is equal to or higher than a predetermined threshold value, and sets the dark mode in a case where the lightness in the surroundings of the vehicle 10 detected by the automatic light control sensor is lower than the predetermined threshold value.

According to an aspect of this disclosure, an image processing device includes an acquisition unit that acquires a plurality of images of which imaging target regions partially overlap with each other, the plurality of images being captured by a plurality of imaging units provided in a vehicle as a surrounding situation of the vehicle, a region-of-interest setting unit that sets a plurality of regions of interest included in a plurality of overlapping regions in which two adjacent imaging target regions overlap with each other, and a first setting unit that sets a correction value for correcting brightness of the plurality of images based on first target brightness, in which the first target brightness is a value obtained by adding a first positive value to an average value of brightness of all the regions of interest, and is a value equal to or lower than a first threshold value higher than the first positive value.

With such a configuration, for example, since the first target brightness is the value obtained by adding the first positive value to the average value of the brightness of all the regions of interest, and is the value equal to or lower than the first threshold value higher than the first positive value, it is possible to increase the brightness of the image captured in a relatively dark environment and to prevent the noise component of the image from being emphasized. Therefore, even in a case where a plurality of images captured in the relatively dark environment are joined to display the surrounding image, it is possible to prevent the image from becoming difficult to see.

The image processing device may further include, for example, a mode switching unit that switches between a first mode and a second mode based on information on lightness, in which the first setting unit sets the correction value using the first target brightness in the first mode, and sets the correction value using second target brightness equal to or higher than the first target brightness in the second mode, and the second target brightness is the first threshold value.

With such a configuration, the target brightness can be set depending on the first mode and the second mode. With such a configuration, since the second target brightness is the first threshold value, it is possible to prevent the brightness to be corrected in the first mode from becoming too high.

The image processing device may further include, for example, a second setting unit, in which the first setting unit sets, using the first target brightness, a first correction value for correcting brightness of a first region of interest included in a first overlapping region in which a first imaging target region, which is one of a pair of imaging target regions separated from each other with the vehicle interposed therebetween, and a second imaging target region, which is one of a pair of imaging target regions adjacent to the first imaging target region, overlap with each other, and a second correction value for correcting brightness of a second region of interest included in a second overlapping region in which the first imaging target region and a third imaging target region, which is the other of the imaging target regions adjacent to the first imaging target region, overlap with each other, and the second setting unit sets, using the first correction value and the second correction value, an individual correction value for correcting brightness of a region between at least the first region of interest and the second region of interest in the first imaging target region.

With such a configuration, since the brightness of the region between the first region of interest and the second region of interest is corrected using the individual correction value based on the first correction value and the second correction value, it is possible to prevent the brightness to be corrected in the region between the first region of interest and the second region of interest from becoming too high.

In the image processing device, for example, the second setting unit may calculate the individual correction value based on an interpolation expression for linear interpolation between the first correction value and the second correction value, and a slope of the interpolation expression may be adjustable.

With such a configuration, for example, it is possible to prevent the brightness from becoming extremely high and to prevent the image from becoming unnaturally too bright or too dark.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An image processing device comprising:
an acquisition unit that acquires a plurality of images of which imaging target regions partially overlap with each other, the plurality of images being captured by a plurality of imaging units provided in a vehicle as a surrounding situation of the vehicle;
a region-of-interest setting unit that sets a plurality of regions of interest included in a plurality of overlapping regions in which two adjacent imaging target regions overlap with each other; and
a first setting unit that sets a correction value for correcting brightness of the plurality of images based on first target brightness,
wherein the first target brightness is a value obtained by adding a first positive value to an average value of brightness of all the regions of interest, and is a value equal to or lower than a first threshold value higher than the first positive value.

2. The image processing device according to claim 1, further comprising:
a mode switching unit that switches between a first mode and a second mode based on information on lightness,
wherein the first setting unit sets the correction value using the first target brightness in the first mode, and sets the correction value using second target brightness equal to or higher than the first target brightness in the second mode, and
the second target brightness is the first threshold value.

3. The image processing device according to claim 1, further comprising:
a second setting unit,
wherein the first setting unit sets, using the first target brightness, a first correction value for correcting brightness of a first region of interest included in a first overlapping region in which a first imaging target region, which is one of a pair of imaging target regions separated from each other with the vehicle interposed therebetween, and a second imaging target region, which is one of a pair of imaging target regions adjacent to the first imaging target region, overlap with each other, and a second correction value for correcting brightness of a second region of interest included in a second overlapping region in which the first imaging target region and a third imaging target region, which is the other of the imaging target regions adjacent to the first imaging target region, overlap with each other, and
the second setting unit sets, using the first correction value and the second correction value, an individual correction value for correcting brightness of a region between at least the first region of interest and the second region of interest in the first imaging target region.

4. The image processing device according to claim 3,
wherein the second setting unit calculates the individual correction value based on an interpolation expression for linear interpolation between the first correction value and the second correction value, and
a slope of the interpolation expression is adjustable.
